(19) United States
(12) Patent Application Publication
(10) Pub. No.: US 2014/0236059 A1
(43) Pub. Date: Aug. 21, 2014

(54) CARPAL TUNNEL RELIEF DEVICE

(71) Applicant: Jae S. Son, Rolling Hills Estates, CA (US)

(72) Inventor: Jae S. Son, Rolling Hills Estates, CA (US)

(21) Appl. No.: 13/769,364

(22) Filed: Feb. 17, 2013

(51) Int. Cl. A61H 1/00

(52) U.S. Cl. CPC A61H 1/006
USPC 601/134

(57) ABSTRACT

A carpal tunnel relief device is configured for adhesive application to a skin area above the median nerve of the distal forearm, wrist or a palm of the subject and includes a middle curved portion shaped to pull the skin and surrounding soft tissues away from the median nerve therefore releasing compression of the median nerve and pain associated with carpal tunnel syndrome. Resilient flexible member may be incorporated with the device or inserted in a pocket of a flexible fabric after its adhesion to the skin.

### BACKGROUND

The present invention relates generally to external devices for relief of compressed tissue. More particularly, the invention describes a spring plate configured to rearrange soft tissue in the area of a human wrist so as to relief median nerve compression, a condition generally known as a carpal tunnel syndrome.

“Carpal tunnel syndrome”, as well as many cases of tendinitis and other cumulative trauma disorders (CTD's) of the wrist and forearm (which are all commonly referred to as Carpal Tunnel Syndrome in this application), result from repeated trauma to the tendons and soft tissue structures that pass through the wrist. Excessive pressure on the carpal tunnel contents causes pain and tingling sensation along the distribution of the median nerve, which are the classic symptoms of this condition. Other typical symptoms are numbness and tingling in the thumb, index finger, middle finger, and radial half of the ring finger. Additional common manifestations of this condition include burning dysesthetic wrist pain, as well as loss of grip strength and dexterity. Symptoms are often worse at night and can be exacerbated by forceful activity and extreme wrist positions.

Carpal tunnel syndrome can be diagnosed to a high degree of specificity by history and physical examination. While Tinel's sign—lightly tapping (“percussing”) over the nerve to elicit a sensation of tingling or “pins and needles” in the distribution of the nerve—and a positive Phalen's maneuver where the subject is asked to hold their wrist in complete and forced flexion (pushing the dorsal surfaces of both hands together) for 30-60 seconds are classic clinical signs of the syndrome, while hypalgesia and weak thumb abduction are more predictive of abnormal nerve conduction studies.

Direct nerve conduction tests are also used to determine if the median nerve is being pinched. For this test, electrodes are placed across the median nerve at the distal finger and on the arm. An electrical pulse is initiated at one electrode and the time it takes to reach the other electrode is measured to determine if there is any compression of the nerve. Higher nerve compression makes the signal weaker and causes it to travel slower.

Carpal tunnel syndrome affects approximately 3 percent of adults in the United States. It is the most commonly diagnosed entrapment neuropathy. Carpal tunnel syndrome is a frequent complication of pregnancy, with a prevalence reported as high as 62%. Median nerve function is impaired in virtually all pregnant women during the third trimester, even in the absence of symptoms. In one study, 30% of frequent computer users complained of hand paresthesias, 10% met clinical criteria, and only 3.5% had abnormal nerve conduction. In another study, the overall self-reported prevalence of tingling/numbness in the right hand at baseline was 10.9% for computer users and interview follow up confirmed that prevalence of tingling/numbness due to the median nerve was 4.8%.

Current mainstream non-surgical treatments of carpal tunnel syndrome include rest, restriction from traumatizing activities, splinting the wrist in a neutral position, anti-inflammatory medication, and cortisone injections.

While many clinical studies are published on non-surgical treatments of carpal tunnel syndrome, their conclusions vary between the researchers. One summary paper of 20 randomized clinical studies showed strong and moderate evidence for the effectiveness of oral steroids, steroid injections, ultrasound, electromagnetic field therapy, nocturnal splinting, use of ergonomic keyboards compared with a standard keyboard, and traditional cupping versus heat pads in the short term. However, there is limited evidence to indicate that splinting, acupuncture, yoga, and therapeutic ultrasound may be effective in the short to medium term of up to 6 months. Another study found moderate supporting evidence for ultrasound in the midterm. Despite limited efficacy, these conservative treatments have a negligible incidence of serious complications and should be used more widely until surgical procedures can be improved to have comparable safety profile.

Some form of wrist support or a splint is normally used in the early stages of treatment. These devices are used in an attempt to delay progression of the condition or as an adjunct to some other treatment in an effort to lessen the pain and aid in the return to normal function that are clearly of benefit are neutral-angle wrist splinting, with a reported success rate of 37%. Subsequent to surgery, wrist splints are frequently used to support the wrist and aid in recovery.

There is strong evidence that local corticosteroid injections give short-term relief (two to four weeks), for carpal tunnel syndrome patients. Steroids are reported to provide initial relief in up to 70% of patients but frequent relapses are common. Moreover, although higher doses of steroid injections seem to be more effective in the midterm, the benefits of steroids injections are not maintained in the long term.

Open carpal tunnel release is the most commonly performed surgical procedure for this condition. Open surgery involves an incision on the palm about an inch or two in length. Through this incision, the skin and subcutaneous tissue is divided, followed by the palmar carpal fascia, and ultimately the transverse carpal ligament to allow more room for the contents of the carpal tunnel, i.e., an increase in the diameter-to-contents ratio.

Endoscopic techniques involve one or two smaller incisions (less than half inch each) through which instrumentation is introduced including a synovial elevator, probes, knives, and an endoscope used to visualize the underside of the transverse carpal ligament. The endoscopic methods do not divide the subcutaneous tissues or the palmar carpal fascia to the same degree as the open surgery method does.

About 70-90% of patients have good-to-excellent long-term outcomes with surgical open carpal tunnel release, but some portion (about 8%) of patients are worse off after the surgery due to co-morbid conditions such as diabetes, poor health status, thoracic outlet syndrome, double crush, alcohol and smoking.

While the individual's risk for developing carpal tunnel symptoms may vary, repeated exposure to repetitive motions at the workplace, account for an increasing cost in terms of workers compensation claims, lost productivity and settlements. These conditions have now surpassed back injury as the No. 1 cause of workers compensation costs.

Splints and supports are often the earliest form of treatment and prevention because it is inexpensive and simple to use. If the efficacy of these devices could be improved, the benefit to the patient and the economy would be significant. However, the cause of carpal tunnel such as over working, lack of exercise or stretching, poor ergonomic setup all needs to be addressed to obtain long term relief.

Prior art describes many splints and various supporting devices designed for treating the symptoms of the carpal tunnel syndrome. Below described patents are incorporated herein in their respective entireties.

Some examples of wrist braces and supporting devices may be found in U.S. Design Patent No. 339,866 and U.S. Pat. No. 4,883,073. Such supports typically include metal or some type of reinforcing part to restrict or limit wrist or hand movement. Other examples are shown in U.S. Pat. Nos. 4,047,250, 4,883,073 and 5,267,943. These devices typically include a part that fits around the thumb and hand such as a thumb loop, or some other means of securing the device to the arm and hand to prevent slippage. Devices like those referenced above, either partially or totally limit or inhibit flexion and/or extension movements of the wrist while also restricting abduction and adduction movements. Dexterity of the hand, wrist and fingers is generally compromised.

U.S. Pat. No. 4,048,991 shows a device with a circumferential rigid member that compresses the wrist in a so-called neutral position. U.S. Pat. Nos. 4,628,918 and 5,921,949 describe a corrective support designed specifically for the treatment of a carpal tunnel syndrome by wrapping a wrist strap with a Velcro fastening mechanism with an inflatable bladder mounted in the wrist strap that squeezes the sides of the wrist.

U.S. Pat. No. 4,966,137 utilizes a metal diamond structure to compress and squeeze the sides of the distal forearm, i.e. the radius and ulna in an attempt to alter the carpal tunnel. U.S. Pat. No. 5,372,575 represents yet another type of support, which is intended to compress musculoskeletal structures and achieve a therapeutic effect via removable bladder and foam padding underneath a Velcro strap. U.S. Pat. Nos. 5,468,220 and 5,256, 136 attempt to stretch the flexor retinaculum using a metal bracelet with adjustable springs and compression plates.

U.S. Pat. No. 6,244,265 is related to the present invention in that it is attached to a skin via an adhesive layer. This device is a nasal dilator that includes an elongated substrate, with or without a dilating component or portion, having top and bottom surfaces and a pressure-sensitive adhesive disposed on the bottom surface.

U.S. Pat. No. 6,315,748 is an orthopedic device for the treatment of physical disorders characterized by region(s) of localized, undue compression of body tissue leading to nerve compression and/or damage, such as carpal tunnel syndrome. This invention includes a central, resilient, stretchable tensioning segment placed on the back of a subject's hand, whereupon three straps are pulled and adhered to the subject's palm in a fashion to flatten the palm by applying continuous tensile forces through the straps which is supposed to reduce the median nerve compression and alleviate symptoms.

The above referenced devices fail to account for the dynamics of bone and joint movement and the structural dynamics of the carpal tunnel. Bones and joints are known to generally resist compressive forces. Therefore a simple compression of the bones and joints of the wrist, whether straight line or circumferential, would be resisted and would not significantly alter the tension associated with the flexor retinaculum or the palmar carpal ligament.

Therefore, a need exists for a simple to use and inexpensive device capable of providing lasting relief for carpal tunnel syndrome. Ideally, such device should be non-invasive, inexpensive, and suitable for self-application by the subject.

### SUMMARY

Accordingly, it is an object of the present invention to overcome these and other drawbacks of the prior art by providing a novel carpal tunnel release device configured to relieve compression of the median nerve and surrounding tissues.

It is another object of the present invention to provide a carpal tunnel relief device which is non-invasive and can be self-applied.

It is a further object of the present invention to provide a carpal tunnel relief device that causes reshaping of the soft tissues of the wrist in a manner that is beneficial for carpal tunnel relief.

It is yet a further object of the present invention to provide a carpal tunnel device that applies continuous tension on the soft tissues of the wrist area so as to provide continuous pressure relief.

The present invention is broadly concerned with improved method and devices for the treatment of physical disorders characterized by a region of localized, undue compression of body tissue, for example carpal tunnel syndrome, by directly applying negative pressure (pulling tension) to the affected area. In so doing, the device of the invention relieves pressure on the median nerve, carpal ligaments and other soft tissue structures of the wrist while allowing full and unrestricted motion of the wrist, hand and fingers. Once the tissue compression is relieved, a normal (or medically-assisted) healing process may take place providing for a longer lasting relief.

The device of the invention is a resilient flexible member having a middle portion covered with a strong biocompatible pressure sensitive adhesive on its concave side for attaching to the skin of the subject. The curvature and the elasticity of the flexible member are selected in such a way as to provide a continuous pulling action on the part of the skin attached to the middle portion of the flexible member when the device is applied to the distal forearm, wrist, or palm area of the subject above the projected position of the median nerve. The ends of the flexible member in turn are configured to compress the skin of the subject in areas away from the median nerve, whereby allowing the soft tissues under the device to shift their positions and to relief the compression of the median nerve.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a depiction from a palmar side of the general wrist anatomy showing the path of the median nerve;

FIG. 2 is a general illustration of the carpal tunnel relief device of the invention placed on the wrist of the subject;

FIG. 3 is a general illustration of the device of the invention placed on a palm area of the subject;

FIG. 4 is a general illustration of two devices placed on both the wrist and the palm areas of the subject;

FIGS. 5a and 5b are a perspective view and a side view of the first embodiment of the carpal tunnel relief device of the invention;

FIGS. 6a, 6b, and 6c are a perspective view, a bottom view and a side view of the device of the invention sized for application on the palm area of the subject;

FIGS. 7a and 7b are cross-sectional views of the wrist of the subject before and after deployment of the device of the present invention;

FIGS. 8a and 8b are a bottom view and a side view of the second embodiment of the invention;

FIGS. 9a and 9b are a bottom view and a side view of the third embodiment of the invention;

FIGS. 10a and 10b illustrate the third embodiment of the present invention before and after deployment;

FIGS. 11a, 11c and 11c are a side view, a view before deployment and a view after deployment of the fourth embodiment of the invention;

FIG. 12 shows a side view of the fifth embodiment of the present invention;

FIG. 13 is a side view of the sixth embodiment of the present invention;

FIG. 14 is an illustration of the seventh embodiment of the present invention including an applicator for the device;

FIG. 15 is an illustration of the seventh embodiment in which the applicator is assembled with a device in preparation for deployment;

FIG. 16a is a side and top illustration of the eighth embodiment of the present invention in its 1^{st} state—before deployment; and

FIG. 16b is a top side and cross sectional illustration of the eighth embodiment of the present invention in the 2^{nd} state, in which the device constantly pulls on tissue after deployment (wrist tissues are omitted from this drawing).

### DETAILED DESCRIPTION OF THE PREFERRED EMBODIMENTS OF THE INVENTION

The following description sets forth various examples along with specific details to provide a thorough understanding of claimed subject matter. It will be understood by those skilled in the art, however that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

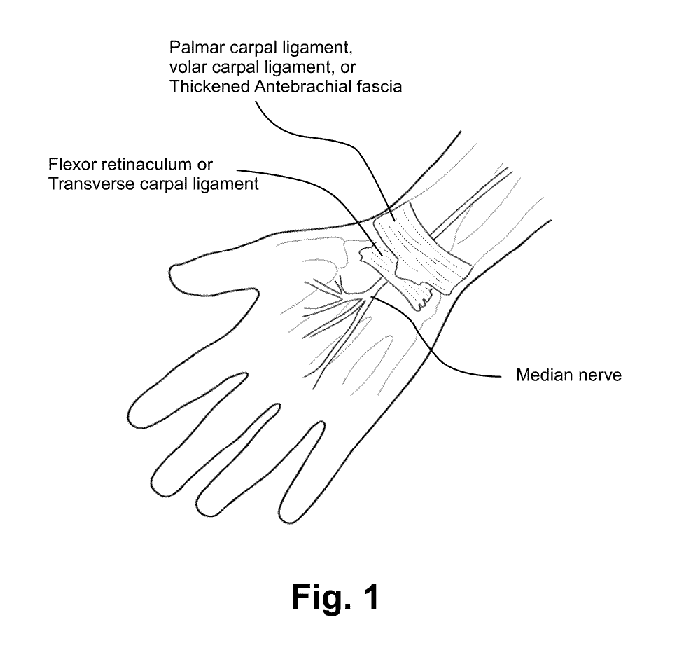

FIG. 1 shows a general position of the median nerve traversing an inner part of the arm including areas in a distal forearm, inner wrist and a palm of the subject. The carpal tunnel is generally composed of a bony arch formed by the radius, ulna and carpal bones and closed by the flexor retinaculum which anchors the base of the arch together. The flexor retinaculum is a thick, relatively unyielding ligamentous band that crosses the groove on the palmer surface of the carpal bones.

The palmar carpal ligament (also known as volar carpal ligament) is a term that is often used in anatomy to describe the thickened portion of antebrachial fascia on the anterior of the wrist. The palmar carpal ligament is a different structure than the flexor retinaculum of the hand, but the two are frequently confused. The palmar carpal ligament lies superficial and proximal to the flexor retinaculum. The palmar carpal ligament is continuous with the extensor retinaculum of the hand, which is located on the posterior side of the wrist.

The antebrachial fascia is a dense, membranous investment, which forms a general sheath for the muscles and gives off from its deep surface numerous intermuscular septa, which enclose each muscle separately. Over the Flexor tendons as they approach the wrist it is especially thickened, and forms the palmar carpal ligament.

The median nerve passes through the carpal tunnel adjacent the flexor retinaculum and between it and the flexor tendons and their bursa. The carpal tunnel has just enough space to accommodate these structures. Carpal tunnel symptoms may be exacerbated when tissue compression of the median nerve persists and prevents healing to take place. In fact, in patients with naturally narrow carpal tunnel, there is present a vicious cycle of rubbing of the nerve by surrounding tendons causing irritation, inflammation and swelling, which further compresses and disturbs the median nerve.

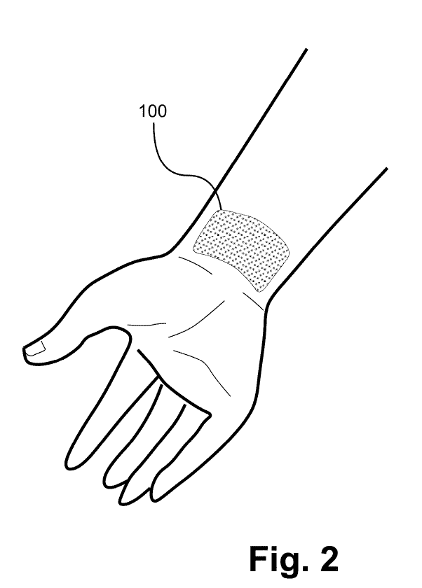

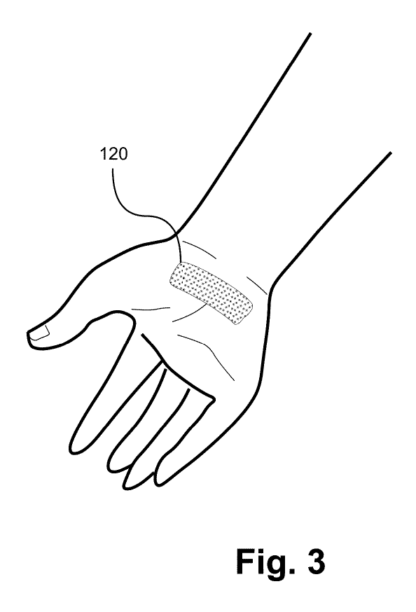

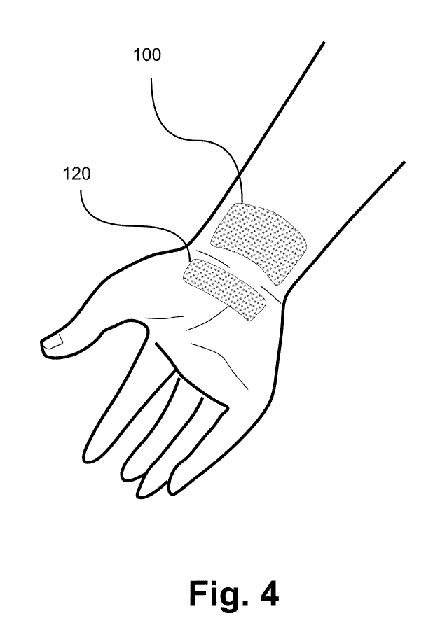

FIG. 2 generally shows the device 100 of the invention placed over a skin area of the inner wrist above the projected location of the median nerve. FIG. 3 shows a location of the device 120 of the invention over the palm area of the subject. FIG. 4 shows both devices 100 and 120 positioned over the inner area of the arm of the subject along the projected position of the median nerve.

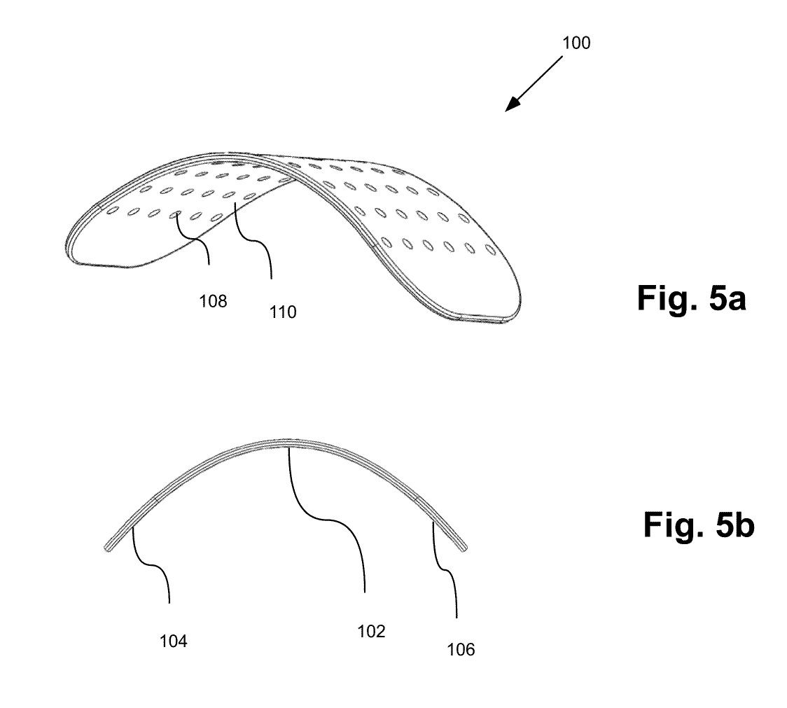

FIG. 5a shows a general view of the carpal tunnel relief device 100 with FIG. 5b showing its side view. The device 100 may include a flexible resilient member, which is generally 0.3-2 mm thin. The flexible member may include a curved middle portion 102 and a periphery which may include a first end 104 and a second end 106. At least the curved middle portion 102 (and in other embodiments the entire device) is supplied with a pressure sensitive adhesive layer 110 on the concave side thereof. The adhesive may be selected to be strong enough to pull on the skin area with sufficient force. In embodiments, biocompatible and preferably hypoallergenic adhesives with at least 100 g/in or higher peel strength may be used. Such adhesive may also be selected to be waterproof and allowing the skin to breathe therethrough.

The body of the device 100 may be made from plastic or include a metal resilient backbone. Because the biomechanical forces of the hand, wrist, tendons, ligaments and other soft tissues are significant, in order to alter the mechanical structure of the carpal tunnel, the stiffness of the body material has to be sufficient to resist these forces. At the same time, since the tissue and skin are sensitive to consistent pressure, attaching hard rigid objects thereto may generate pressure sores and cause discomfort to the subject. Therefore in embodiments, the body of the device may be made from polyethylene with a tensile modulus of about 0.2 to about 0.8 GPa. In other embodiments, a low density polypropylene may be used with a tensile modulus of about 1.5 GPa. Yet in other embodiments, the device may be made from such material groups as polyurethanes, polycarbonates, ABS polymers with tensile modulus in a range from about 0.1 to about 3 GPa or from a spring steel plate. In embodiments, a spring steel plate may also be embedded in plastic. The thickness, width and curvature of the device may be adjusted to provide more or less tension on the skin area over the median nerve based on the individual's wrist size.

The curved middle portion of the device is generally arch-shaped and has a radius of curvature less than that of the cross-section of the skin area above the median nerve. Selecting that shape is aimed at providing for a continuous pulling of the skin when the device is adhesively applied to the inner arm of the subject. In embodiments, the shape of the middle portion is selected to have a radius of curvature between about 0.5 and 3 inches. In one embodiment, the radius of curvature may be selected to be about 1 inch.

In embodiments, the device 100 may include a plurality of perforations 108 allowing more of the skin area to be exposed to air through these perforations to breathe and also allowing monitoring skin conditions while the device 100 is in use.

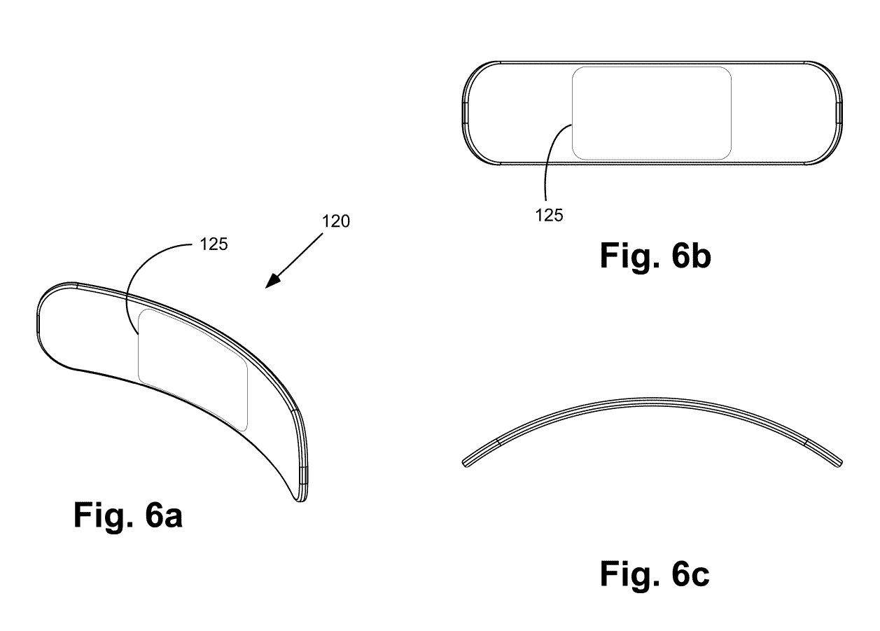

FIGS. 6a through 6c show several views of the device 120 of the invention which is more narrow than the device 100 and is better adapted for use on the palm area of the subject. FIGS. 6a and 6b also show the underside of the adhesive 125 which is applied only on the curved middle portion 102 which allows the peripheral portion of the device 104 and 106 to slide as the middle portion 102 is pressed against the skin.

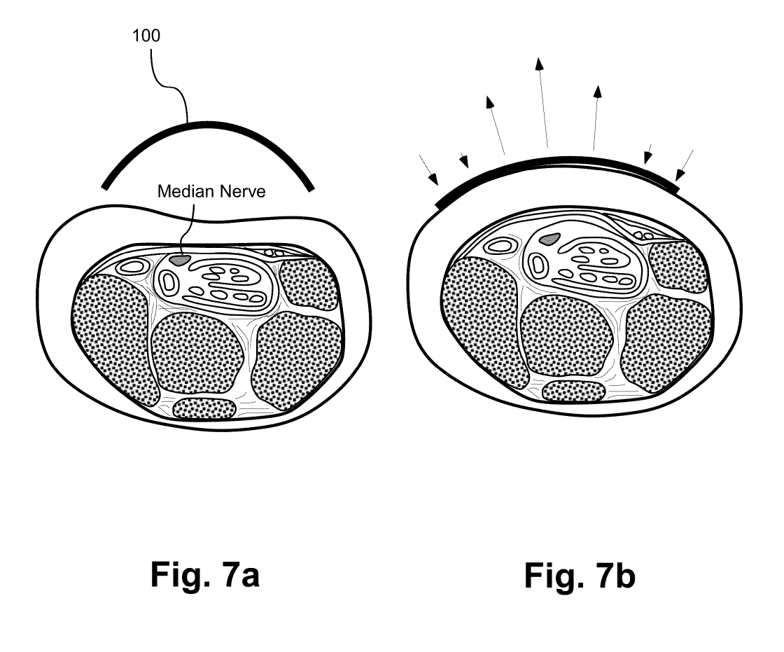

In its most basic form, the device 100 may be adhesively applied to the skin area over the median nerve as shown in FIGS. 2-4. During application, the device 100 may be first placed orthogonally to the projected path of the median nerve (FIG. 7a). The adhesive layer may be then exposed (by removing for example a protective paper liner) after which the device may be deformed to unfold the curvature of the median portion 102 and applied over the skin area (FIG. 7b). Once applied, the device will cause the middle portion 102 to pull on the skin area and other local soft tissues up while the periphery of the device pushes down on the skin areas away from the location of the median nerve.

Equilibrium of pressure and tension is then found when the soft tissues are pulled up and away directly above the median nerve while soft tissues are pushed down in locations to the side of the median nerve. This equilibrium is maintained by a continuous pulling action provided by the device causing a continuous shift in the position of the soft tissues relative to the median nerve leading to a continuous pressure relief thereof. Once the pressure is relieved on the median nerve, natural healing processes may take place. In embodiments, such healing process may also be enhanced with adjunct treatments or procedures, such as anti-inflammatory medications.

Device of the present invention may be worn as needed for example over the course of several days to a few weeks to provide continuous relief of pain and protect the area of the median nerve from occasional compression caused by manipulation of the arm of the subject. Avoidance of occasional rubbing of the nerve by surrounding tendons and ligaments may create favorable conditions for healing of the inflammation so that the pain does not come back when the device is removed from skin.

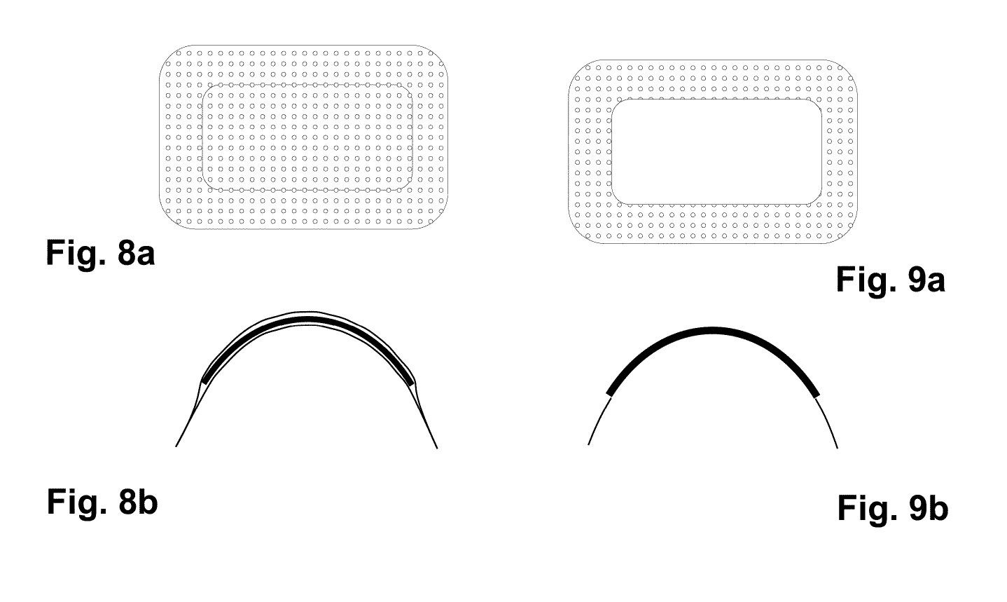

FIGS. 8a and 8b show an alternate configuration of the device 100 in which the stiffening resilient flexible insert (shown as a thick black line) can be placed inside a pocket formed in otherwise pliable and flexible material such as fabric. The pliable material may include a pressure sensitive adhesive layer on the concave side thereof. The pocket may have an opening on the convex side of the pliable material. In use, the pliable material is first attached to the skin area and then the resilient stiffening insert is placed inside the pocket to cause lifting of the skin above the median nerve.

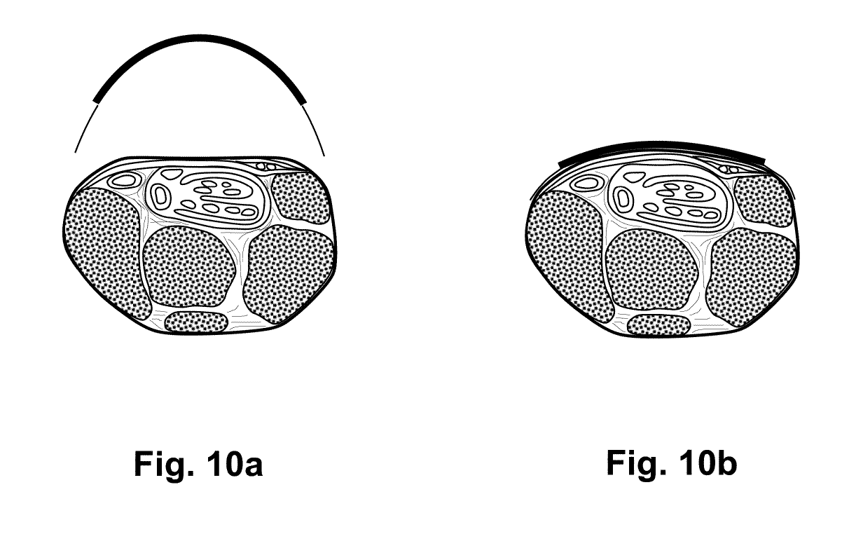

FIGS. 9a and 9b show yet another alternate embodiment in which the pliable material such as a fabric or paper is first applied to the skin using a first adhesive layer on the concave side thereof. A stiffening resilient member may then be applied on top of the pliable fabric and adhered to the fabric using a second layer of adhesive—either on the concave side of the resilient member or the convex side of the pliable fabric. Position of the device and soft tissues are shown in FIG. 10a before and FIG. 10b after application as described above.

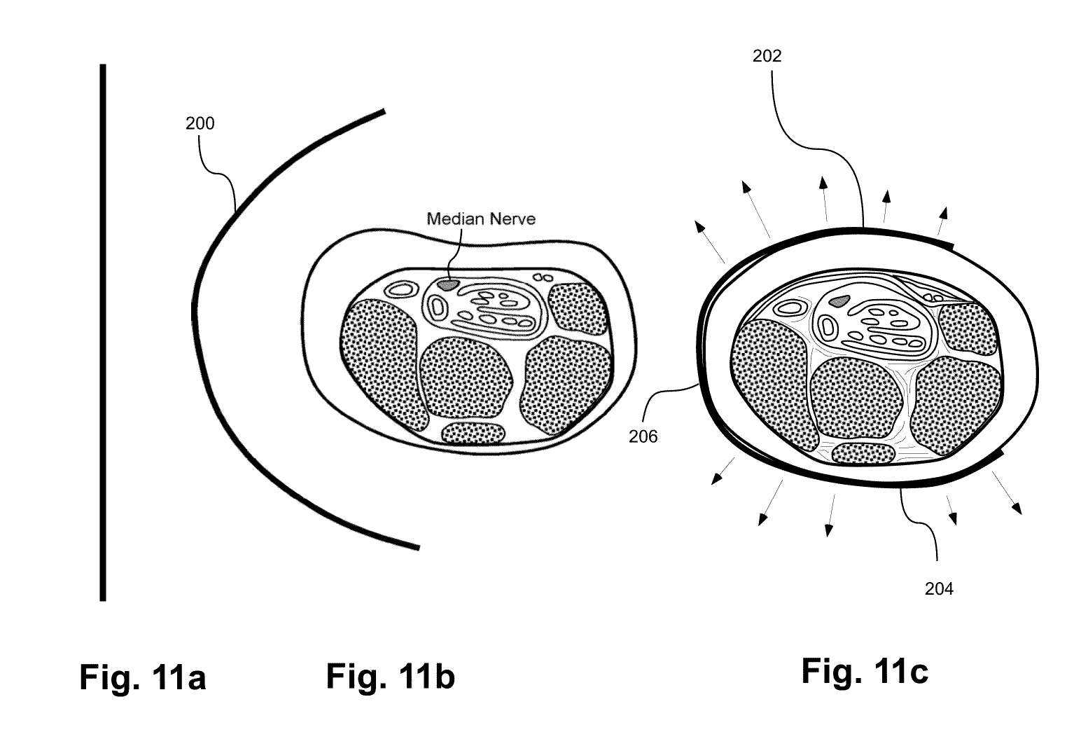

FIGS. 11a through 11c show yet another embodiment of the present invention. The device of the invention 200 is initially a straight strip (FIG. 11a) which is convenient for packaging and shipping purposes. To apply the device, an adhesive layer is exposed on one side of the strip and it is then bent to place the ends in contact with the inner and the outer skin areas of the wrist or a distal forearm (FIG. 11b). The inner skin area may be selected to be above the projected location of the median nerve. The strip 200 may be then released and its resilient nature will cause continuous tension on both sides of the wrist whereby relieving tissue compression on the median nerve.

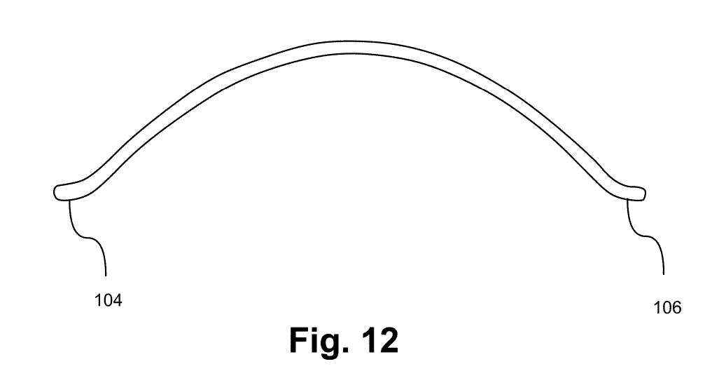

To avoid compression of the skin by the stiff ends 104 and 106 of the device 100, they may be curved as well to distribute the skin pressure over a broader area and avoid hard pinching of the skin. This configuration is illustrated in FIG. 12.

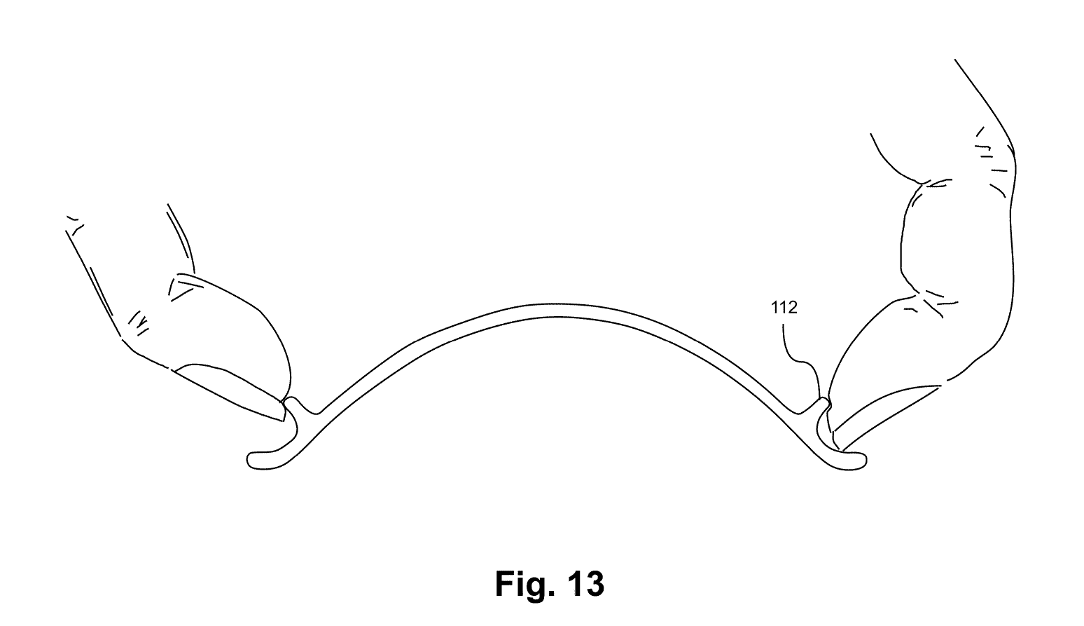

To facilitate initial unfolding of the device 100 during its application to the skin, one or preferably two protrusions 112 on the convex side of the device may be provided on both ends—see FIG. 13. Protrusions 112 may be appropriately shaped to be engaged with using fingers of a human hand as seen in FIG. 13. Holding the device using these protrusions allows straightening the device to make it easier to put in full contact with the skin area above the median nerve.

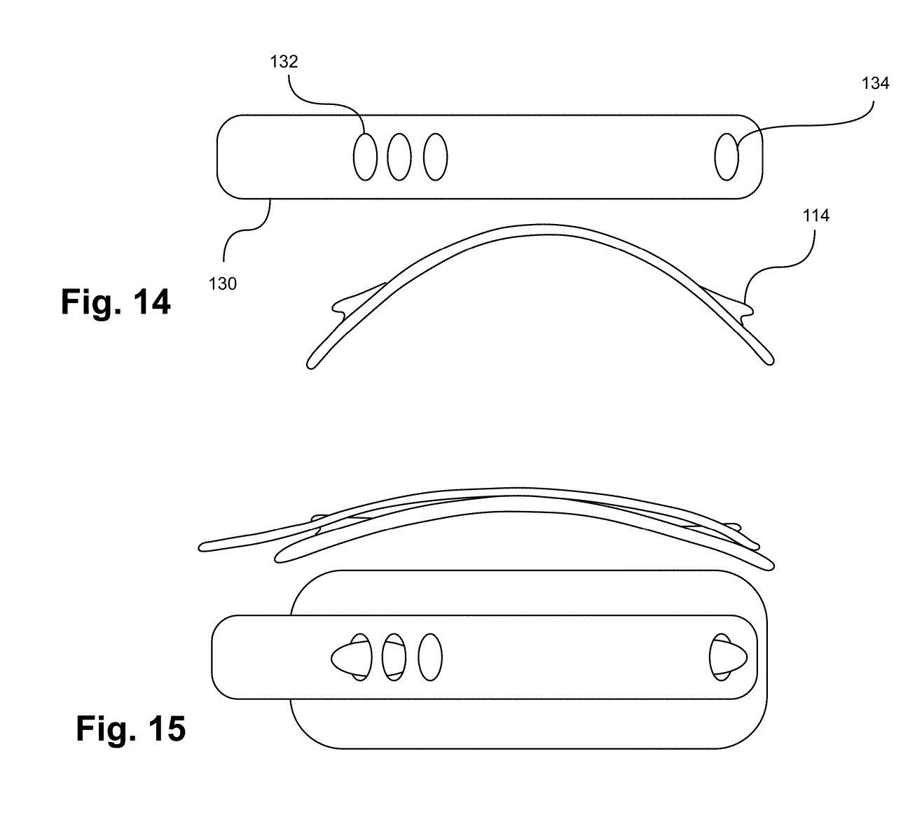

FIGS. 14 and 15 show the concept of an applicator 130 designed to engage the protrusions 114 of the device 100. FIG. 14 shows the top view of the applicator 130 having at least one opening 134 on one end thereof and one or more openings 132 on the other end. The size and location of these openings 132 and 134 are selected to assure proper engagement with the protrusions 114 of the device. To allow application of devices of various sizes, more than one opening 132 may be provided. To prepare the device 100 for application, it may be first manually straightened so as to engage protrusions 114 with the appropriate openings 132 and 134 in the applicator 130. This assembly of the device and the applicator is shown in the upper panel of FIG. 15. The adhesive application of the device to the wrist of the subject then follows and the applicator is disengaged and removed afterwards.

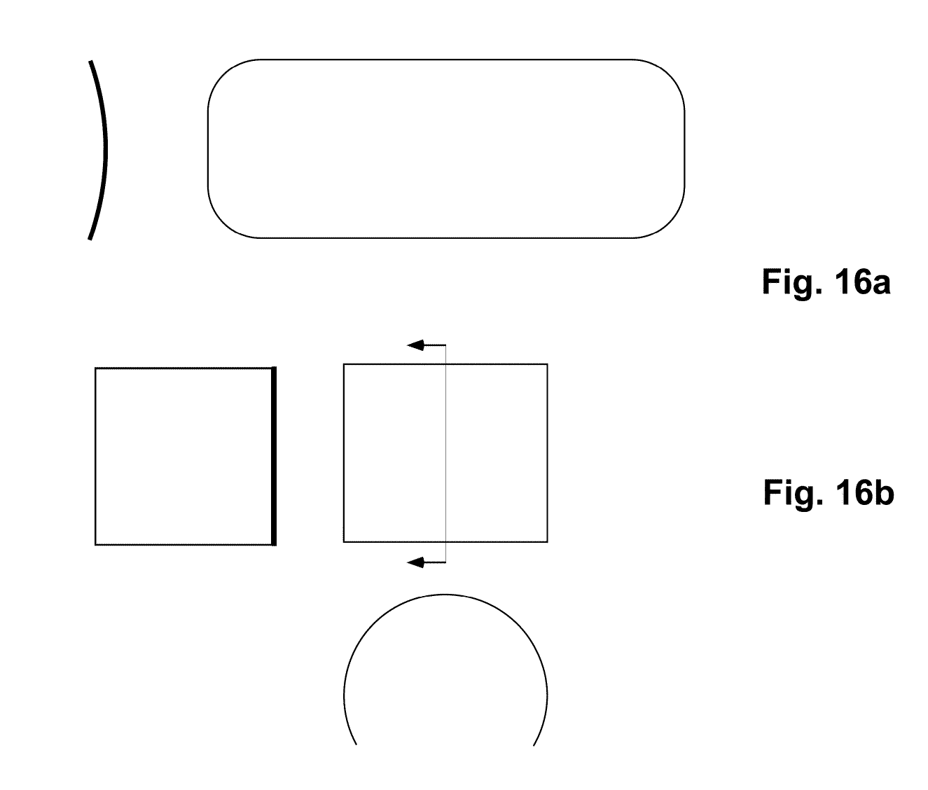

FIG. 16 shows another embodiment of the device in which the resilient flexible member is made from a strip of resilient metal such as spring steel. Shown in FIG. 16a is a 1^{st} state of the device in which an arched in cross-section (looking from a side—left panel of FIG. 16a) spring steel strip allows retention in a straight line (shown as a top view on the right panel of FIG. 16a.) The device is unfolded into this position before applying to the wrist. FIG. 16b shows a top view of the 2^{nd} curved configuration of the device after application to the wrist (wrist and soft tissues are not shown) and the left part of FIG. 16b shows a straight (flat) cross-section of the device after its deployment. Lower part of FIG. 16b shows a curved side view of the device after its application. The radius of the curvature would be smaller than the wrist radius to provide sufficient pulling action over the median nerve.

The herein described subject matter sometimes illustrates different components or elements contained within, or connected with, different other components or elements. It is to be understood that such depicted architectures are merely examples, and that in fact many other architectures may be implemented which achieve the same functionality.

Although the invention herein has been described with respect to particular embodiments, it is understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A carpal tunnel relief device configured for an adhesive application to a skin area of an inner distal forearm, an inner wrist or a palm of a subject above a median nerve, said device comprising a resilient flexible member having a curved middle portion and a periphery, said middle portion having a concave side with a pressure sensitive adhesive layer thereon,
wherein said device is resiliently deformed upon adhesively applying thereof to said skin area such that said curved middle portion provides continuous tension lifting said skin area and underlying soft tissues while said periphery provides continuous skin compression at least on some skin areas outside said skin area above said median nerve,
whereby said device shifts said underlying soft tissues away from said median nerve and relieves compression of said median nerve.

2. The carpal tunnel relief device as in claim 1, wherein said resilient flexible member is an elongated curved flexible strip, said periphery includes a first end adjacent to said curved middle portion and a second end adjacent to said curved middle portion.

3. The carpal tunnel relief device as in claim 2, wherein said first end has a curved first edge and said second end has a curved second edge, said first edge and said second edge are curved to reduce pressure concentration on either side of said skin area above said median nerve.

4. The carpal tunnel relief device as in claim 1, wherein said curved middle portion is arch-shaped when not deformed with a radius of curvature selected to be from about 0.5 inch to about 3 inches.

5. The carpal tunnel device as in claim 1 wherein said resilient flexible member is made from a polymer with a tensile modulus ranging from about 0.1 GPa to about 3 GPa.

6. The carpal tunnel relief device as in claim 4, wherein said radius of curvature is about 1 inch.

7. The carpal tunnel relief device as in claim 1, wherein said pressure sensitive adhesive is selected to have a peel strength of at least 100 g/in.

8. The carpal tunnel relief device as in claim 1, wherein said curved middle portion included a plurality of venting perforations therethrough to provide ventilation of the skin when said device is adhesively applied to said skin area above said median nerve.

9. The carpal tunnel relief device as in claim 2, wherein said first end and said second end include a respective first protrusion and a second protrusion extending from a convex side of said resilient flexible member and facing away from said skin area, said first protrusion and said second protrusion are shaped to facilitate deforming of said resilient flexible member to unfold said curved middle portion during adhesive application of said device, whereby facilitating complete contact between said skin area above said median nerve and said curved middle portion.

10. The carpal tunnel relief device as in claim 9, wherein said first protrusion and said second protrusion are shaped for engaging by fingers of a human hand.

11. The carpal tunnel relief device as in claim 9, wherein said first protrusion and said second protrusion are shaped for releasable attachment to an applicator.

12. The carpal tunnel relief device as in claim 1 further including a pliable flexible material with a pressure sensitive adhesive layer on one side thereof and a pocket with an opening on the other side thereof, said pocket sized to accept a stiffening resilient flexible insert, said stiffening insert is curved to form said curved middle portion of said device.

13. The carpal tunnel relief device as in claim 1 further including a pliable flexible material with a first pressure sensitive adhesive layer on one side thereof, said resilient flexible member further includes a second adhesive layer on a concave side thereof adapted for adhesively applying said resilient flexible member above said pliable flexible material.

14. The carpal tunnel relief device as in claim 1, wherein said resilient flexible member is a spring steel strip defining a 1^{st} state prior to deployment and a 2^{nd} state after deployment, said 1^{st} state is characterized in the strip being unfolded in a straight line and retained in that position due to a curved cross-section thereof; said 2^{nd} state is characterized by said strip having a flat cross-section while assuming a curved shape after deployment about said inner distal forearm, said inner wrist or said palm of the subject.
